(19) United States
(12) Patent Application Publication
(10) Pub. No.: US 2026/0219950 A1
(43) Pub. Date: Jul. 30, 2026

(54) RESOURCE MANAGEMENT FOR MACHINE LEARNING SYSTEMS AND APPLICATIONS

(71) Applicant: Nvidia Corporation, Santa Clara, CA (US)

(72) Inventors: David Yastremsky, Seattle, WA (US); Penn Tasinga, Mercer Island, WA (US)

(21) Appl. No.: 19/041,817

(22) Filed: Jan. 30, 2025

(51) Int. Cl. G06F 9/50; G06F 9/48

(52) U.S. Cl. CPC G06F 9/5044; G06F 9/4881

(57) ABSTRACT

Example embodiments described herein relate to a resource scheduling system that incorporates user sentiment analysis to enhance responsiveness in computing environments. The embodiments include a lightweight model for estimating compute requirements based on user prompts and organization-specific inputs, as well as a second model for predicting response times based on hardware allocation. Additionally, it features a sentiment computation model that evaluates user engagement metrics and feedback to generate sentiment scores. A control panel allows system administrators to prioritize resource allocation by adjusting the influence of compute requirements, response times, and user sentiment.

### TECHNICAL FIELD

This disclosure relates to machine learning models and resource management.

### BACKGROUND

With the rise of large language models, concerns have arisen over the latency of responses due to hardware costs and shortages. However, all users are not equally sensitive to latency at any given time. For example, some users may ask a large language model a question and then switch windows while they wait for the answer. Others will want an immediate answer and may get frustrated if the response is not coming in quickly enough. Conventional resource scheduling technologies often rely on static algorithms that prioritize compute requirements and response times without considering the emotional states or satisfaction levels of users. This oversight can lead to inefficiencies, as users may experience delays or inadequate responses that do not align with their expectations, ultimately diminishing their overall satisfaction. In environments where both cost and hardware availability are constrained, such rigid systems can cause frustration, resulting in a disconnect between user needs and the system's capabilities. Additionally, the inability to dynamically assess user sentiment can leave organizations blind to critical feedback that could inform improvements in service delivery.

### BRIEF DESCRIPTION OF THE DRAWINGS

Various embodiments in accordance with the present disclosure will be described with reference to the drawings, in which:

FIG. 1 illustrates a computing system according to example embodiments;

FIG. 2 illustrates a computing system according to example embodiments;

FIG. 3A illustrates a computing system according to example embodiments;

FIG. 3B illustrates a computing system according to example embodiments;

FIG. 3C illustrates a computing system according to example embodiments;

FIG. 3D illustrates a computing system according to example embodiments;

FIG. 3E illustrates a computing system according to example embodiments;

FIG. 4 illustrates a computing system according to example embodiments;

FIG. 5A illustrates a process according to example embodiments;

FIG. 5B illustrates a process according to example embodiments;

FIG. 5C illustrates a process according to example embodiments;

FIG. 6 illustrates components of a distributed system that can be utilized to update or perform inferencing using a machine learning model, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment;

FIGS. 15A and 15B illustrate a data flow diagram for a process to train a machine learning model, as well as client-server architecture to enhance annotation tools with pre-trained annotation models, in accordance with at least one embodiment;

FIG. 16 illustrates a computer system according to one or more example embodiments;

FIG. 17 illustrates a computer system according to one or more example embodiments;

FIG. 18A illustrates a generative language model system according to one or more example embodiments;

FIG. 18B illustrates a generative language model system according to one or more example embodiments; and

FIG. 18C illustrates a generative language model system according to one or more example embodiments.

### DETAILED DESCRIPTION

Example embodiments described herein integrate user sentiment analysis into resource scheduling, which is particularly relevant in environments where computing resources are constrained. By incorporating measures of urgency and emotional states, some example embodiments can dynamically adjust its resource allocation based on real-time user expectations, thus enhancing overall user satisfaction. These embodiments address not only the immediate needs of users but also tailor responses to their emotional states, making it a more responsive and user-centric solution compared to traditional systems that focus solely on compute requirements or response times.

Furthermore, these example embodiments represent an improvement over existing technologies by addressing a significant technological problem: the inefficiency in resource allocation due to static scheduling models that fail to consider user sentiment. The example embodiments may use lightweight models for estimating compute requirements and response times while simultaneously evaluating user sentiment through various engagement metrics. These multifaceted example embodiments allow for prioritization of resources, ultimately enhancing efficiency in computing environments by ensuring that hardware is allocated based on both technical needs and user satisfaction. By doing so, it reduces resource waste and improves performance under constraints related to cost and availability.

The example embodiments described herein may be used in one or more computing environments. In cloud computing environments, where resources are often limited and demand fluctuates, integrating user sentiment analysis allows for real-time adjustments in resource allocation. For instance, during peak usage times, example embodiments can prioritize requests from users exhibiting high urgency or emotional distress, ensuring that critical tasks are completed promptly. In other example embodiments, customer service platforms can assess the sentiment of incoming queries. For example, if a customer expresses frustration in their request, the system can prioritize their issue over less urgent inquiries, ensuring that high-stress situations are handled swiftly. Virtual assistants can implement this system to better understand user requests. For example, if a user asks for urgent information (like emergency procedures), the assistant can prioritize this request and provide a quicker response, even if it means delaying less urgent queries. In telehealth services, example embodiments can prioritize patient inquiries based on emotional urgency. For example, a patient expressing anxiety about symptoms can be fast-tracked for a consultation compared to routine check-ups.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

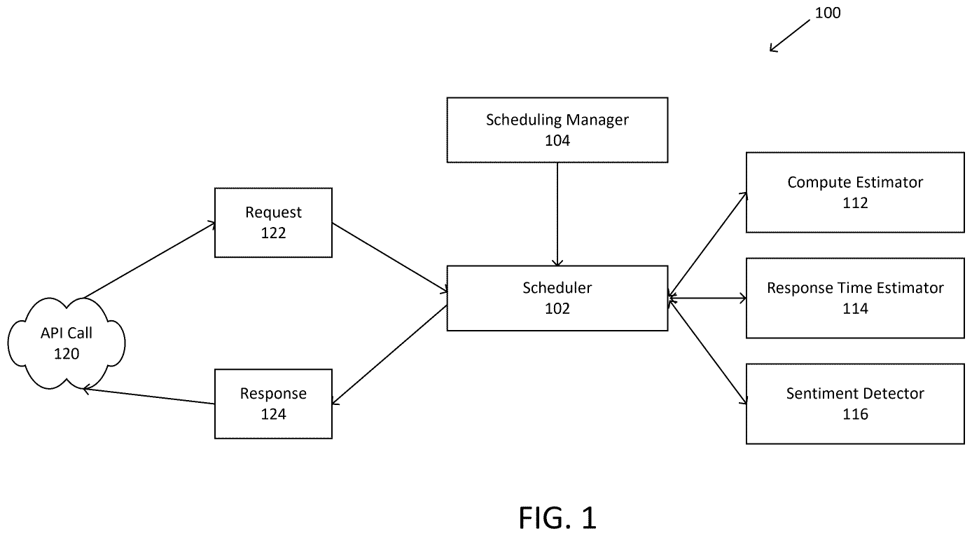

FIG. 1 illustrates a system 100 for scheduling a response to a response or query from a user. Some or all of the elements of the system 100 may be performed by one or more server processors, modules, or cloud computing resources. The system 100 may include a scheduler 102 which can receive a request 122, generate a response 124 to the request 122, and transmit the response 124 to the request 122. Based on the received request 122, the scheduler 102 may compute one or more estimates associated with generating the response 124 to the request 122. In example embodiments, the scheduler 102 may utilize one or more trained models, such as, without limitation, a compute estimator 112, a response time estimator 114, and a sentiment detector 116. Each of the compute estimator 112, response time estimator 114, and sentiment detector 116 may include one or more machine learning models, each trained separately to generate one or more outputs.

The request 122 may include any number of queries or statements generated by a user or administrator. In example embodiments, the request 122 may be a common query such as “What is the weather today?”, “When is the football game?”, and “When is the next election?” In other embodiments, the request 122 may be very specific to the user, such as “Help me write this birthday card,” “Tell me directions to get home,” or “What should I have for dinner?” In still other embodiments, the request 122 may indicate an urgent query or request, such as “How to perform CPR?”, “How to get directions out of a neighborhood or city during an emergency?”, or “Does this dish contain a certain allergen?” In addition to the core query or statement, the request 122 may also include tokens and metadata that provide further context and enhance the processing of the request 122. Tokens may represent individual elements or keywords—such as words, subwords, characters, phonemes, etc.—extracted from the request 122 that can be used for various purposes, such as natural language processing (NLP) or machine learning. For example, in the query “What is the weather today?”, tokens might represent “weather” and “today.” These tokens may help the system understand the key components of the request 122, allowing for more accurate interpretation and response generation.

The request 122 may further include metadata, including supplementary information that describes the context of the request 122. This metadata can include details such as the timestamp of when the request 122 was made, the user's location, the device being used (e.g., smartphone, tablet, or desktop), and any relevant user preferences or historical data. For instance, if a user frequently asks about weather updates for a specific city, the metadata could indicate this preference, allowing the system 100 to tailor responses accordingly. Additionally, metadata may include information about the urgency of the request 122, such as whether it was submitted during a time of high activity, if it follows a pattern of urgent queries, or if the request is received from a location currently experiencing a particular event (such as an earthquake, tornado, fire, etc.). This context can help prioritize the request 122 in the processing queue, ensuring that time-sensitive inquiries are addressed promptly or sooner than other less time-sensitive inquiries. The request 122 may be received and transmitted over a wired or wireless network.

In example embodiments, scheduler 102 may input the request 122 into one or more various models. The compute estimator 112 may include a machine learning model trained to estimate a compute requirement for generating the response 124 to the request 122. The compute requirement may be based on one or more inputs, including, without limitation, model architecture, such as the number of parameters and the type of model being used. In other example embodiments, the compute requirements may be based on input characteristics such as, without limitation, token count, token complexity, and context length of the request 122, all of which may influence processing demands. The expected output requirements, such as response length and complexity, may also be considered in estimating compute requirements. Furthermore, hardware specifications, including the type and number of processing units, memory constraints, and network latency, may be considered. Model configuration aspects like batch size and the size of the key-value cache in transformer models may also be considered. Environmental factors, including thermal constraints and power availability, can also limit performance and, consequently, compute capabilities. Optimization techniques like pruning and quantization may reduce compute requirements, depending on the level of optimization applied. Other factors described elsewhere herein may also be considered.

In example embodiments, the response time estimator 114 may be a machine learning that may estimate the time needed to generate the response 124 to the request 122. The response time estimator 114 may include as inputs, without limitation, the content and length of the request 122 itself, including one or more tokens comprising the request 122. Additionally, the response time estimator 114 may also include as inputs the average hardware allocation of one or more past responses, and the type and performance of the hardware, such as GPUs or DPUs, which directly affect the speed of computation. The specific hardware locations may also be considered, as different processing units may have varying capabilities and efficiencies. The response time estimator 114 may consider other inputs, such as the expected output requirements, including response length and complexity, as well as model configuration elements like batch size and precision of computation, which may further influence the time estimation.

In example embodiments, the sentiment detector 116 may include one or more machine learning models configured to generate one or more user sentiment scores. For example, one model may be used—such as a large language model (LLM), vision language model (VLM, small language model (SLM), perception model, etc.—or a combination of models may be used in an ensemble to identify different sentiment characteristics of the user in order to identify a final user sentiment score. Where an ensemble is used, in embodiments, a fusion or arbiter machine learning model, or a rule-based algorithm (e.g., a weighting algorithm), may process each of the outputs of the ensemble in order to generate a final user sentiment score.

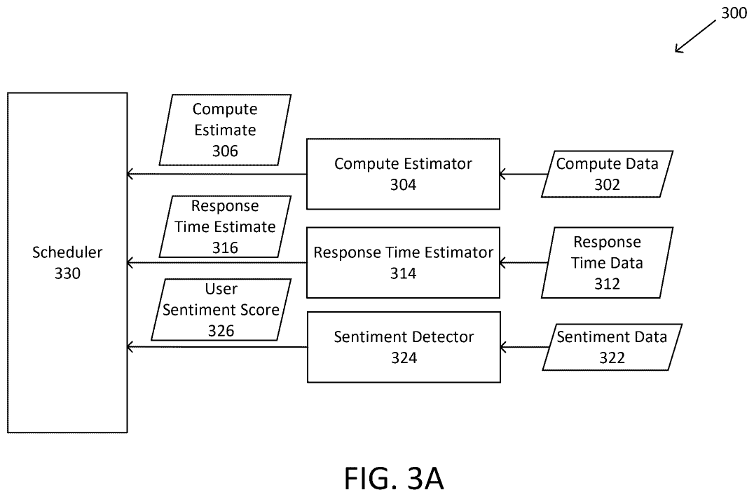

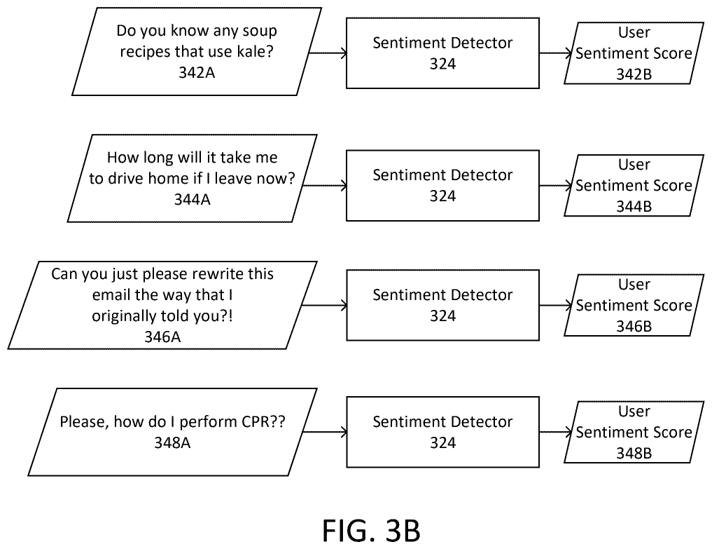

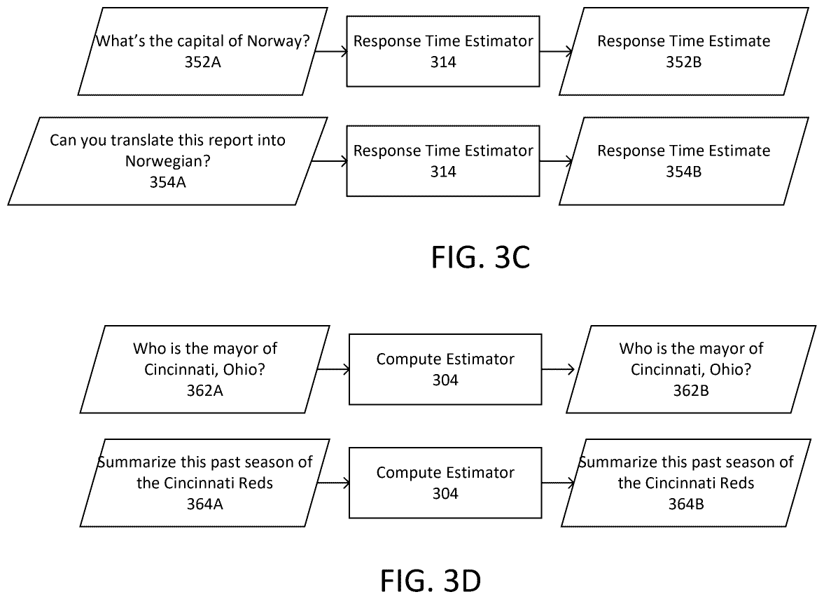

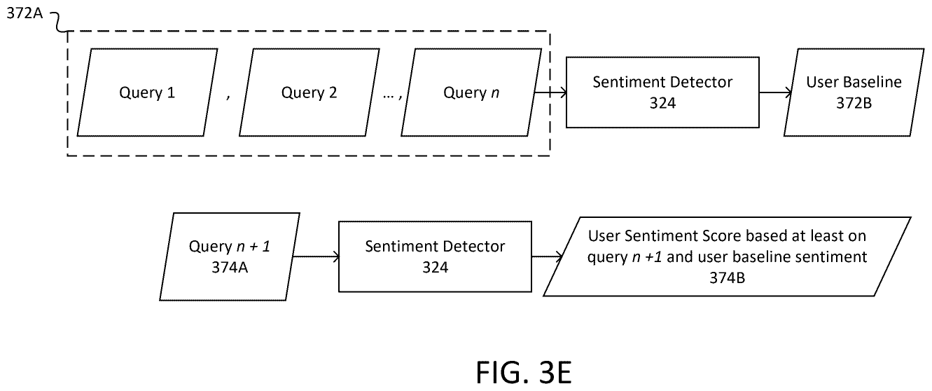

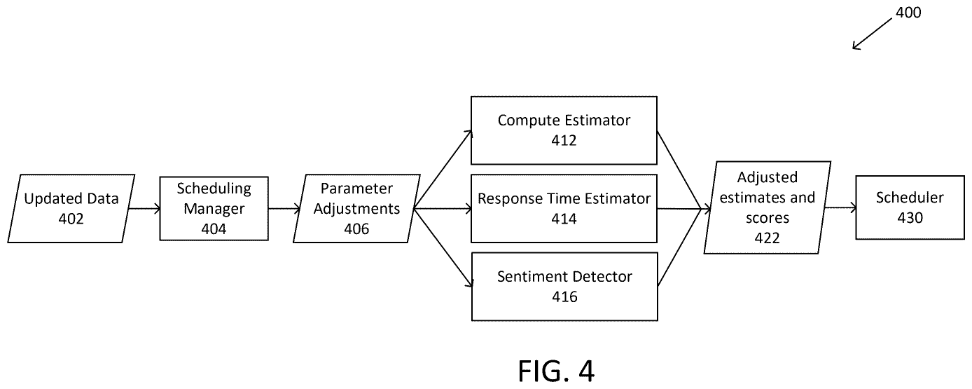

The sentiment detector 116 may include as inputs the request 122 itself, how long it takes the user to write the request 122 or respond to past requests, whether the user is asking the same question one or more times in repetition, past responses or prompts from the same user, a trend of one or more sentiment scores from the user, users'answers to one or more check-ins transmitted by the system 100, and context from the request 122 indicating one or more moods or emotional states associated with the user. In other example embodiments, the sentiment detector 116 may be trained on data specific to the user who submitted the request 122, including without limitation user biographical data, as well as data from other users who have submitted requests to the system 100. The sentiment detector 116 may be trained to associate one or more emotional states, desires, or senses of urgency based on one or more aspects of the request 122, including, without limitation, the content of the request 122 itself, such as the vocabulary and punctuation of the request 122; the length of the request 122; and the urgency expressed in the request 122. Further examples are discussed with further reference to FIGS. 3A, 3B, and 3E. In other example embodiments, the models may consider user data or request metadata collected via one or more audio or visual measurement devices associated with the user's computer device, including without limitation video data of the user, audio data of the user, browsing activity of the user (e.g., what the user is doing while they wait for the response 124 such as switching tabs on their browser). In other example embodiments, the metadata can include without limitation the frequency and type of interactions the user has had with the system over time, including the number of queries submitted and the types of responses received; user feedback on previous responses, such as ratings or comments indicating satisfaction or dissatisfaction with the answers provided; the time at which the user submits the request 122, which may correlate with different emotional states or urgency levels (e.g., late-night queries may indicate stress or urgency); the type of device used to submit the request 122 (e.g., smartphone, tablet, desktop), which may influence user behavior and emotional state; the length of time the user spends in a session before submitting a request 122, which may indicate their level of engagement or frustration; the user's geolocation data at the time of the receiving of the request 122, which may provide context for certain requests (e.g., asking for local services or information) and/or may indicate environmental or other happenings at the user's location (e.g., severe weather, fires, natural disaster, etc.); data from the user's social media interactions, such as posts or comments, which may reflect their current mood or emotional state; information about the user's preferences or settings within the system 100, which may influence how the sentiment detector interprets their requests 122; patterns or trends in the user's sentiment scores over time, which may indicate changes in mood or emotional state; additional context surrounding the request 122, such as previous conversations or related responses that may provide insight into the user's current emotional state; biographical such as age, gender, and occupation; data about external factors that may influence the user's emotional state, such as weather conditions or current events; visual or audio information retrieved—with user consent—from their device(s), which may help visually or audibly identify their current mood, state, feelings, etc. ; and/or other data types or sources.

In some example embodiments, the user sentiment score may be a single number, for example, a number between 1 and 10 or any other suitable range. In such example embodiments, a higher user sentiment score is associated with a greater sense of urgency, whereas a lower user sentiment score is associated with a lower sense of urgency. In other example embodiments, the sentiment detector 116 may generate a plurality of user sentiment scores, each relating to a specific mood or emotional state associated with the user based on the prompt, user historical data, and external data. For example, the sentiment detector 116 may generate user sentiment scores for frustration, fear, anxiety, uncertainty, sadness, sarcasm, or any other suitable indication of the user's mood or emotional state. The sentiment detector 116 may individually generate each of these scores or generate an ultimate user sentiment score based at least on each of these individual scores. In some example embodiments, the sentiment detector 116 may generate these one or more scores discussed herein as one or more vectors in a multidimensional vector space, where each of these sentiment scores represents a vector in an N-dimensional space. Furthermore, the ultimate user sentiment score may be a product of each of these user sentiment scores, such that the final user sentiment score is a vector taken as a product of each of these sub-scores.

Each of the compute estimator 112, response time estimator 114, and sentiment detector 116 may be lightweight models designed to be efficient in terms of resource usage, making it suitable for deployment in environments with limited computational power, memory, or storage. In some example embodiments, the models may be of a predetermined size with few parameters and a smaller architecture, which reduces the amount of memory required to store the model. In addition to size, the models may be configured to be computationally efficient, requiring less processing power for both training and inference. The models may also consume less energy during operation, making them more suitable for battery-powered devices. Furthermore, the models may utilize fewer input features, focusing on the most relevant ones to reduce complexity and improve performance without sacrificing accuracy.

Based on the compute estimate from the compute estimator 112, the response time estimate from the response time estimator 114, and the sentiment score from the sentiment detector 116, the scheduler 102 may schedule the response 124 to the request 122. In example embodiments, the scheduler 102 may schedule the response 124 ahead of one or more other responses to earlier-received requests. In such example embodiments, the scheduler 102 may determine that the response 124 has some combination of compute requirements, response time, and sentiment score such that the scheduler 102 prioritizes the response 124 ahead of the responses to earlier-received requests. As a nonlimiting example, the scheduler 102 may determine that the user request 122 comprises a very urgent request, a request that is time-sensitive, or a request that indicates (based at least on the content of the request 122 as well as other information described elsewhere herein) that the user wants to receive the response 124 relatively quickly, or that the user will quickly abandon their query or request 122 if they do not receive a response in a certain amount of time. In other embodiments, the scheduler may additionally determine that the user's request 122 has a low compute requirement or low response time relative to other responses in a queue. In other embodiments, any combination of factors may be considered by the scheduler 102 in determining or scheduling the response 124. In some example embodiments, a sentiment score may indicate that the user is frustrated and requires a quick response. However, if the response time and compute estimate are relatively high, the scheduler 102 may schedule the response 124 normally, i.e., in the normal course of action. That is, the scheduler 102 will not schedule this response 124 ahead of any earlier responses. In other example embodiments, the opposite may be true, such as when the sentiment detector 116 does not detect a high sense of urgency or great desire to receive a quick response 124. However, if the response 124 requires relatively little compute and a relatively little time, the scheduler may schedule the response 124 ahead of earlier responses despite the fact that the request 122 has a relatively low sentiment score. Other such combinations not described herein may be made.

In example embodiments, the request 122 and the response 124 may be transmitted and received through an API call 120. An API call may include a request made by a client to a server, allowing the client to access specific features or data from the server's application. This interaction may follow a defined API protocol. An API call may involve a client sending a structured request to a server, which processes the request and returns a response. In this context, the client could be a user interface or application that needs to retrieve or send data to the server. For instance, when a user submits a query through a web application, the application generates an API call that includes the necessary parameters, such as the user's input and any relevant metadata. The API may be formatted according to the specifications of the API, which may include the use of HTTP methods (such as GET, POST, PUT, or DELETE) to indicate the type of operation being requested. For example, a GET request might be used to retrieve data, while a POST request could be used to submit new data to the server. The server then processes the request, performs any necessary computations or data retrieval, and sends back a response that contains the requested information or the result of the operation.

In example embodiments, the API call 120 facilitates the interaction between the client and the server, ensuring that the request 122 is properly formatted and that the server can understand and process it. The response 124, which may include the results of the request or any relevant data, is then sent back to the client through the same API call. This process allows for efficient communication and data exchange, enabling the application to function smoothly and respond to user inputs in real-time.

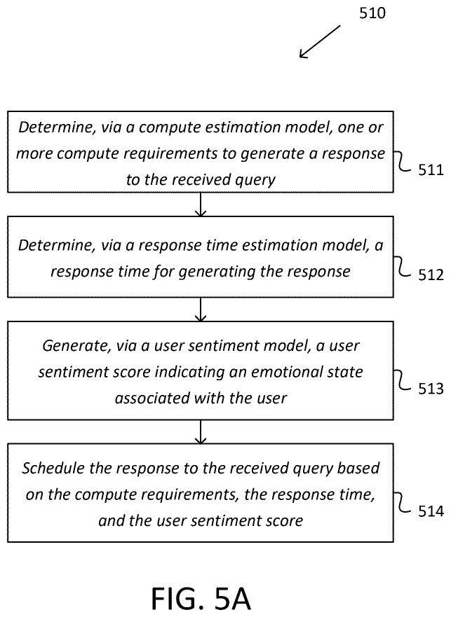

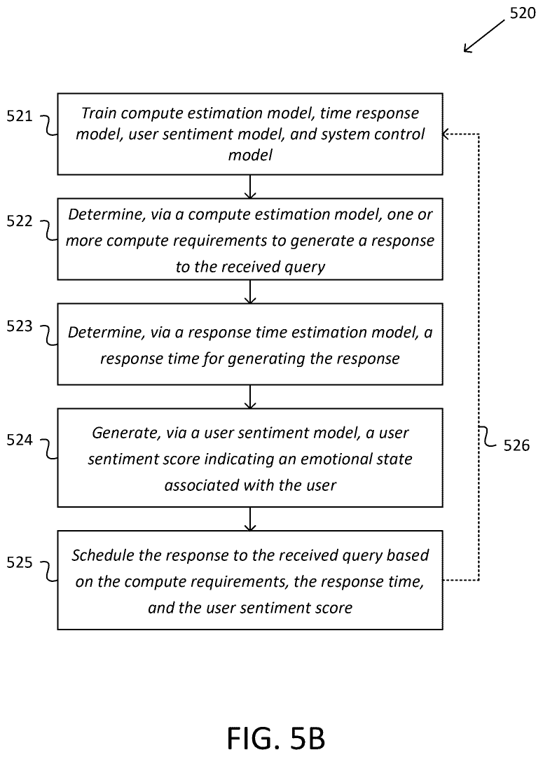

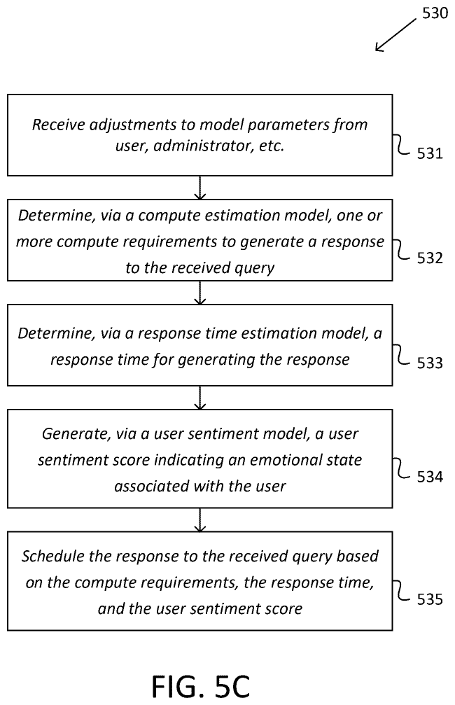

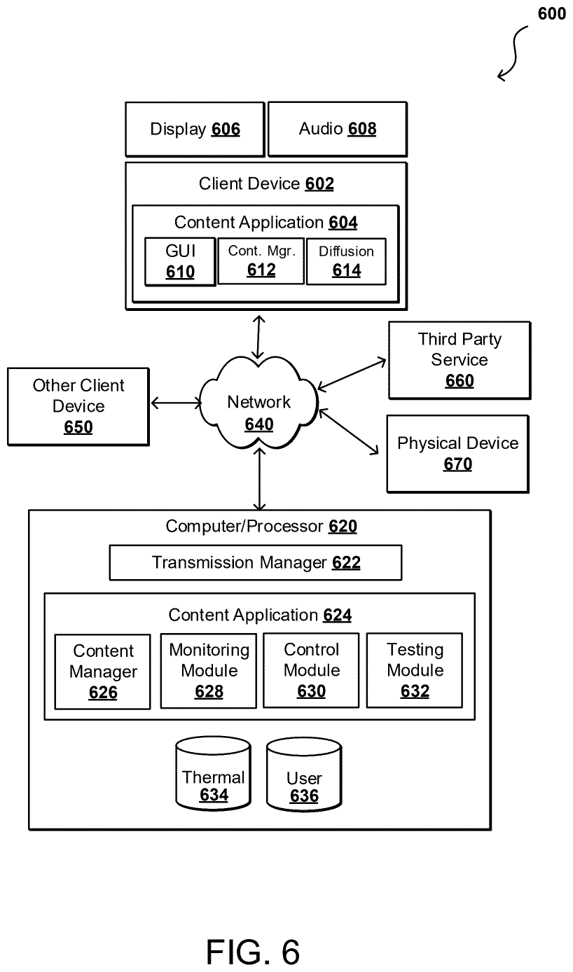

The system 100 may also include a scheduling manager 104. The scheduling manager 104 may maintain control over or change one or more of the parameters associated with the compute estimator 112, the response time estimator 114, and the sentiment detector 116. The scheduling manager 104 may change the parameters of these models when, as a nonlimiting example, any number of internal or external data prompts a change to the scheduler 102's treatment of requests 122. In still other embodiments, the scheduling manager may receive one or more requests from a user or administrator to adjust some of the weights of the models as described with further reference to FIGS. 4 and 5C.

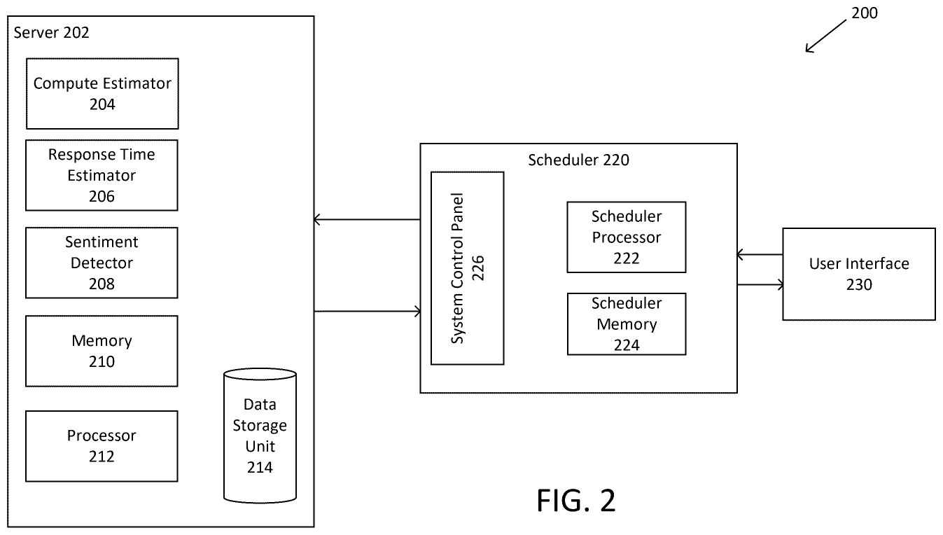

FIG. 2 illustrates a system 200 according to example embodiments. The system 200 may include a server 202, a scheduler 220, and a user interface 230. The server 202 may include one or more modules, models, processors, memories, and data storage units, such as a compute estimator model 204, a response time estimator model 206, a sentiment detector model 208, a memory 210, a processor 212, and a data storage unit 214. The scheduler 220 may include a scheduler processor 222, a scheduler memory 224, and a system control panel 226. The user interface 230 may be associated with one or more user devices or computing devices. Although FIG. 2 illustrates the server 202, it is understood that in some example embodiments, the scheduler 220 may be integrated into the server 202.

As illustrated in FIG. 2, the scheduler 220 interacts with the user interface 230 through one or more wired or wireless networks. In example embodiments, the user interface 230 may include a user device, such as a smartphone, tablet, personal computer, desktop computer, in-vehicle infotainment system, talking or smart kiosk, a smart or digital speaker or display device, a television, a VR/AR/MR device or system, and/or other computing device, configured to allow the user to generate and transmit one or more requests via wired or wireless networks to the scheduler 220. The scheduler 220 can include at least a scheduler processor 222, a scheduler memory 224, and a system control panel 226. The scheduler processor 222 may read one or more sets of computer-readable instructions from the scheduler memory 224. Upon receiving one or more requests from the user interface 230, the scheduler 220, via the scheduler processor 222, may process the one or more requests before transmitting the one or more requests to the server 202. As a nonlimiting example, the scheduler 220 may perform input validation, data enrichment, data categorization, data prioritization, and other preparatory actions prior to transmission to the server 202.

As illustrated in the system 200, each of the compute estimator 204, response time estimator 206, and sentiment detector 208 may be processed on the server 202, separate from the scheduler 220. However, in other example embodiments, the scheduler 220 may be integrated as part of the server 202, in which case the server 202 and scheduler 220 may interact with the user interface 230. The scheduler 220 transmits the one or more requests to the server 202, and the processor 212 may input the requests to each of the compute estimator 204, response time estimator 206, and sentiment detector 208, each of which may have been previously or continuously trained based on one or more metrics as discussed elsewhere herein. The processor 212 may read one or more sets of computer instructions from the memory 210. In other example embodiments, the server 202 may store one or more data items or information related to or including the requests in the data storage unit 214. The compute estimator 204 may generate an estimate of the compute resources necessary to generate a response to the request. The response time estimator 206 may generate or estimate the time needed to produce a response to the one or more requests. The sentiment detector 208 may generate one or more sentiment scores indicating one or more emotional states or senses of urgency associated with one or more requests. When each of the compute estimator 204, response time estimator 206, and sentiment detector 208 has generated its respective outputs, each of these outputs may be transmitted to the scheduler 220. The scheduler processor 222 may analyze each of these outputs and determine, based at least on these outputs, how to schedule the response to the one or more requests.

In some example embodiments, the scheduler 220 may further configure one or more parameters associated with the compute estimator, response time estimator, and sentiment detector via the system control panel 226. The system control panel 226 may retrieve or receive one or more data or information relevant to the generation of the compute estimate, response time estimate, and sentiment score. For example, the control panel 226 may receive or retrieve data directly relevant to the prompt, including at least the content of the request and any metadata associated with the request, as well as other external data discussed elsewhere herein, including, without limitation, weather, traffic, time, and other such elements. The system control panel 226 may, based on these inputs, determine that at least one or more of the parameters of each of the compute estimator 204, response time estimator 206, and sentiment detector 208 may need to be adjusted in light of the one or more inputs discussed elsewhere herein. As a nonlimiting example, the system control panel 226 may determine that, due to the time of day, many users may be traveling home from work, and thus, requests associated with getting directions home or asking about traffic data would factor into the ultimate scheduling of the responses to one or more requests.

FIG. 3A illustrates a process 300 for generating compute estimates 306, a response time estimate 316, and a user sentiment score 326. All of the actions and elements described with reference to FIG. 3A may be performed by one or more processor modules or servers, as discussed with further reference to at least FIGS. 1 and 2. The system can include one or more models, such as the compute estimator 304, response time estimator 314, and sentiment detector 324. Each of these estimators or models may receive as inputs one or more different kinds of data to generate their outputs. For example, the compute estimator 304 may input compute data 302, which can include, without limitation, token count, token complexity, and context length of the request, all of which may influence processing demands. The expected output requirements, such as response length and complexity, may also be considered in estimating compute requirements. Furthermore, hardware specifications, including the type and number of processing units, memory constraints, and network latency, may be considered. Model configuration aspects like batch size and the size of the key-value cache in transformer models may also be considered. Environmental factors, including thermal constraints and power availability, can also limit performance and, consequently, compute capabilities. Optimization techniques like pruning and quantization may reduce compute requirements, depending on the level of optimization applied. Other factors described elsewhere herein may also be considered. The response time estimator 314 may input one or more response time data 312, including, without limitation, the prompt, hardware allocation or average hardware allocation over a predetermined time period, the location of the hardware (including the location of one or more GPUs, DPUs, or similar processing units), and historical or average response times based on ultimately allocated hardware and past responses generated in response to one or more requests. The sentiment detector 324 can use one or more sentiment data 322 as inputs. The sentiment data 322 may include one or more measurements or metrics associated with the request, including, without limitation, the request itself, how long it takes the user to write the request or respond to past requests, whether the user is asking the same question one or more times in repetition, past request or prompts from the same user, a trend of one or more sentiment scores from the user, users'answers to check-ins, and context from the request indicating one or more moods or emotional states associated with the user. In some example embodiments, the sentiment detector may input data such as the vocabulary and punctuation used in the request. Based on their respective inputs, the compute estimator 304 generates one or more compute requirements 306 for generating a response to the request; the response time estimator 314 may generate one or more response time estimates to generate the response to the request; and the sentiment detector 324 may generate a user sentiment score 326 in response to the request. Each of these outputs may be transmitted or shared 330, and upon receiving and analyzing each of these inputs, the system may schedule the response to the request. Furthermore, each of these models includes one or more parameters that may be adjusted one or more times, including in other embodiments described herein.

FIG. 3B illustrates one or more example embodiments of the sentiment detector 324 generating one or more user sentiment scores based on one or more requests. As discussed elsewhere herein, the processes illustrated in FIG. 3B may take place within the server or any other suitable computing device. Although not illustrated in FIG. 3B, the sentiment detector 324 may be trained previously or continuously in response to one or more requests, user data, or any other external data with further reference to FIGS. 1, 5B, 15A, and 15B. Generally, the sentiment detector 324 may generate a user sentiment score that relates to one or more moods, emotional states, or senses of urgency present in the one or more requests from the user. The sentiment detector 324 may generate a high user score indicating that the user is currently in a mood or emotional state associated with desiring a quick response to one or more requests. In contrast, the sentiment detector 324 may generate a low or relatively low user sentiment score upon determining that the user is in a mood or emotional state where they have a relatively low desire to receive a relatively quick response to their requests. As discussed elsewhere herein, the user sentiment score may be based on one or more factors directly related to the one or more requests, as well as historical user data and one or more external data sources.

In some example embodiments, the generation of the user sentiment score may result in a single number, for example, a number between 1 and 10 or any other suitable range. In such examples, a higher user sentiment score is associated with a greater sense of urgency, whereas a lower user sentiment score is associated with a lower sense of urgency. In other example embodiments, the sentiment detector 324 may generate a plurality of user sentiment scores, each relating to a specific mood or emotional state associated with the user based on the prompt, user historical data, and external data. For example, the sentiment detector 324 may generate user sentiment scores for frustration, fear, anxiety, uncertainty, sadness, sarcasm, time sensitivity, or any other suitable indication of the user's mood or emotional state. The sentiment detector 324 may individually generate each of these scores or generate an ultimate user sentiment score based at least on each of these individual scores. In some example embodiments, the sentiment detector 324 may generate these one or more scores discussed herein as one or more vectors in a multidimensional vector space, where each of these sentiment scores represents a vector in an N-dimensional space. Furthermore, the ultimate user sentiment score may be a product of each of these user sentiment scores, such that the final user sentiment score is a vector taken as a product of each of these sub-scores.

An example embodiment's request 342A may include a general knowledge question such as, “Do you know any soup recipes that use kale?” The sentiment detector 324 may generate a user sentiment score 342B based on this request. In this example embodiment, the sentiment detector 324 may generate a relatively low score based at least on a lack of urgency or a general inference from the vocabulary, word choice, and punctuation used in the user request 342A, indicating that the user is in a relatively non-urgent emotional state or mood. Further bases for determining a user sentiment score are discussed with further reference to FIG. 1.

The request 344A may include a time-sensitive request, that is, a request that the sentiment detector 324 determines reflects a mood or emotional state that would require a response that may need to be prioritized over one or more responses to earlier requests. For example, the request 344A may be a question: “How long will it take me to drive home if I leave now?” Based on the content of this prompt, as well as one or more historical user data points and external data, the sentiment detector 324 may generate a user sentiment score 344B. The user sentiment score 344B may be relatively higher than the user sentiment score 342B because the user sentiment score 344B is generated based on the time-sensitive nature of the request 344A. Further bases for determining a user sentiment score are discussed with further reference to FIG. 1.

In some example embodiments, the sentiment detector 324 may infer, based at least on the content of the request, user historical data, and some external data, that the user is in a mood or emotional state associated with requiring an urgent response. For example, the request 346A may be, “Can you please just rewrite this email the way that I originally told you?!” Based on the word choice and punctuation present in this request 346A, the sentiment detector 324 may generate a user sentiment score 346B that is relatively high, at least compared to the user sentiment score 342B, because the user sentiment score 346B indicates that the user is in a mood or emotional state where they are impatient, angry, or in some other mood associated with desiring a quicker response.

In still other example embodiments, the sentiment detector may generate a relatively high user sentiment score based on the content of a request, indicating that the user requires a response relatively soon. For example, the request 348A may state, “Please, how do I perform CPR?” Based on this request 348A, as well as user historical data and external data, the sentiment detector 324 may generate a user sentiment score 348B that is at least relatively higher than the user sentiment score 342B because the user sentiment score 348B is based on the inference that the request to perform CPR may be time-sensitive or indeed a medical emergency. Although FIG. 3B illustrates only a limited number of examples, it is understood that a person of skill in the art may extrapolate these given illustrations to one or more similar or suitable embodiments as described elsewhere herein.

As illustrated in FIG. 3C, the response time estimator 314 may generate one or more response time estimates based on one or more responses. Generally, the response time estimator 314 may generate a response time estimate indicating how much time it is estimated to take to generate a response to a request from a user. This estimate may take on a multi-dimensional form rather or be single numerical measurement of time. In example embodiments, it may include a straightforward numerical value representing the estimated time (e.g., “5 seconds” or “2 minutes”). In other example embodiments, the time estimate could also encompass additional contextual information that provides a richer understanding of the estimate. For instance, an estimated response time of “5 seconds” might be accompanied by dimensions such as complexity level, indicating whether the request is low or high complexity; user history, noting if the user is frequent or new; resource availability, reflecting the current server load; urgency level, categorizing the request as normal or high urgency; and external factors, such as network conditions and time of day. Response time estimates may vary depending on the complexity of the received request, as well as the available hardware and bandwidth resources within the computing environment related to the response time estimator 314.

As discussed elsewhere herein, the response time estimator 314 may perform one or more actions in association with the server 202 or other suitable processing systems. Although not illustrated in FIG. 3C, the response time estimator 314 may be trained previously or continuously based on one or more requests, historical data associated with the user making the request, and one or more external data sources. Generally, the response time estimator 314 may generate a response time estimate indicating how much time it is estimated to take to generate a response to a request from a user. It may ultimately base its decision on how to schedule the response to the user at least on the estimated time generated by the response time estimator 314. Response time estimates may vary depending on the complexity of the received request, as well as the available hardware and bandwidth resources within the computing environment related to the response time estimator 314.

In example embodiments, the response time estimator 314 may analyze at least a request 352A, which states, “What's the capital of Norway?” Based on this request 352A, the response time estimator 314 may generate a response time estimate 352B. Since the request 352A is a relatively short and straightforward general knowledge question, the response time estimate 352B may be relatively low. In contrast, the response time estimator 314 may analyze a more complex or involved request 354A, which states, “Can you translate this report into Norwegian?” Based on this more complex request 354A, the response time estimator 314 may generate a response time estimate 354B, which may be relatively high compared to the response time estimate 352B because the request 354A is not a general knowledge question but will likely involve more complex processing, including language translation and understanding the nuances of languages. The response time estimator 314 may also consider in its calculation of the response time estimates one or more historical data points associated with the user, as well as other external data discussed with further reference to FIG. 1.

FIG. 3D illustrates, according to at least some example embodiments, a compute estimator 304 generating one or more compute estimates based on one or more received requests. The actions illustrated in FIG. 3D may be performed in part by the one or more processors or modules discussed with further reference to FIG. 3A and FIG. 1. The compute estimator 304 may generate the one or more compute estimates based at least on the content of the prompt or request, one or more historical data points associated with the user making the request, and one or more external data sources, as discussed with further reference to FIGS. 1 and 3. An actual compute estimate generated by the compute estimator 304 may take on a multi-dimensional form or take on a single numerical representation of compute resources. While the compute estimate may include a straightforward numerical value representing the estimated compute resources required (e.g., “2 CPU hours” or “500 MB of memory”), it could also encompass additional contextual information that provides a deeper understanding of the estimate. For instance, a compute estimate of “2 CPU hours” might be accompanied by dimensions such as complexity level, indicating whether the request is low or high complexity; historical user data, noting if the user is frequent or new; resource availability, reflecting the current system load; data sources, indicating whether the request can be fulfilled using a single or multiple data sources; and response type, categorizing the request as static or dynamic.

The compute estimator 304 may receive a request 362A, which states, “Who is the current mayor of Cincinnati, OH?” Based on this request 362A, the compute estimator 304 may generate a compute estimate 362B. Because the request 362A is asking a general knowledge question that is not particularly complex, the compute estimate 362B may be relatively low. That is, the compute estimate 362B may indicate that the compute resources needed to generate a response to the request 362A are relatively low compared to other requests. In contrast, the compute estimator 304 may receive a more complex request 364A, which states, “Summarize the past season of the Cincinnati Reds.” Based on this request 364A, the compute estimator 304 may generate a compute estimate 364B. Because the request 364A is not a straightforward general knowledge question and may indeed require analysis and processing of several kinds of information, including sports data, news data, and other knowledge, the compute resources required to generate the response to the request 364A may be higher than at least the response 362B. As discussed elsewhere herein, the compute estimator 304 may also generate one or more compute estimates based at least on general historical user knowledge as well as general external data. Each of the compute estimates 362B and 364B may be shared with a processor, controller, or the scheduler 220, which may determine the scheduling of the response to the one or more requests.

FIG. 3E illustrates a process for generating one or more user baselines 372B based at least on one or more historical data points associated with a user. The actions illustrated in FIG. 3E may be performed at least in part by the sentiment detector 324, a processor, the server 202, or some other suitable computing device. The sentiment detector 324 may receive one or more queries 372 from a particular user. For example, historical queries 372A may include Query 1, Query 2, up to any number of queries N. The sentiment detector 324 may generate one or more sentiment scores based on each or all of the queries 372A. In other example embodiments, the sentiment detector 324 may also consider other data, such as metadata including without limitation the frequency and type of interactions the user has had with the system over time, including the number of requests submitted and the types of responses received; user feedback on previous responses, such as ratings or comments indicating satisfaction or dissatisfaction with the answers provided; the time at which the user submits the request, which may correlate with different emotional states or urgency levels (e.g., late-night queries may indicate stress or urgency); the type of device used to submit the requests (e.g., smartphone, tablet, desktop), which may influence user behavior and emotional state; the length of time the user spends in a session before submitting a request, which may indicate their level of engagement or frustration; the user's geolocation data at the time of the request, which may provide context for certain requests (e.g., asking for local services or information); data from the user's social media interactions, such as posts or comments, which may reflect their current mood or emotional state; information about the user's preferences or settings within the system, which may influence how the sentiment detector interprets their requests; patterns or trends in the user's sentiment scores over time, which may indicate changes in mood or emotional state; additional context surrounding the response, such as previous conversations or related requests that may provide insight into the user's current emotional state; biographical such as age, gender, and occupation, which may help tailor responses and understand user sentiment better; and data about external factors that may influence the user's emotional state, such as weather conditions or current events. Based at least on these user sentiment scores and other user data described herein, the sentiment detector 324 may generate a user baseline 372B. The user baseline 372B may include a baseline mood, emotional state, or average sense of urgency detected in the queries 372A.

In some example embodiments, the sentiment detector 324 may average the user sentiment scores from each of the queries 372A. In other example embodiments, the sentiment detector 324 may not only average the user sentiment scores but also take into consideration the sentiment scores in relation to the sentiment scores of one or more other users, the user's sentiment data with respect to other external data, trends in the user's sentiment scores, or any other data described elsewhere herein. In such embodiments, the sentiment detector 324 may determine one or more trends in user sentiment based on the user sentiment scores from the queries 372A. For example, the sentiment detector 324 may determine that the user's queries 372A contain, relative to the requests of other users, more urgent language and more content indicative of a mood or emotional state that the sentiment detector 324 associates with a greater sense of urgency.

As an example embodiment, the user baseline 372B may be used by the sentiment detector 324 to compensate for a relatively low or relatively high average sentiment score of a particular user. For instance, most users may have an average sentiment score of approximately 5 on a scale from 1 to 10. However, a particular user may have an average sentiment score of 8. This higher average score may be due to any number of reasons, including, without limitation, a particular writing style or the tendency of the user to submit queries or responses only when they want an immediate answer or when it is an emergency. Therefore, even though the sentiment detector 324 receives a query from the user that would, in other circumstances, be considered a particularly urgent request, it may actually be considered an average request in comparison to the many other queries received from this particular user. Thus, the user baseline 372B allows the sentiment detector and scheduler to compensate for users with particularly low or particularly high average sentiment scores.

In example embodiments, the sentiment detector 324 may receive a query or request 374, and based on this query or request 374, the sentiment detector 324 may generate a sentiment score 374B based at least on the content of the query 374A as well as the user's baseline 372B. Although not illustrated in FIG. 3E, the sentiment detector may also consider one or more other historical user data points and other external data in generating the user sentiment score 374B as described with further reference to at least FIG. 1.

FIG. 4 demonstrates a process 400 for adjusting one or more parameters of the compute estimator 412, response time estimator 414, and sentiment detector 416. Generally, each of these models may comprise one or more parameters, e.g., one or more weights and biases, which have been at least partially set by one or more training periods. In some example embodiments, however, these parameters may be adjusted or changed iteratively or continuously in response to one or more updated data points, updated external data, updated user data, or any other information described elsewhere herein. Each of the actions performed in FIG. 4 may be executed by one or more processors, servers, modules, or other computing devices, as discussed elsewhere herein. Updated data 402 may be received or retrieved by the scheduling manager 404. In some example embodiments, the scheduling manager 404 continuously or iteratively receives data through an API call or a similar retrieval mechanism before receiving updates that may be relevant to the one or more machine learning models described herein. Based on this updated data, the scheduling manager 404 may generate one or more parameter adjustments 406. The parameter adjustments 406 may include changes or adjustments to one or more weights and biases of the compute estimator 412, response time estimator 414, and sentiment detector 416.

Having adjusted the parameters, the system may generate one or more adjusted estimates and scores 422, for example, an adjusted compute estimate, an adjusted response time estimate, and an adjusted sentiment score. Adjusted estimates and scores 422 may be transmitted to the scheduler 430, which may analyze and determine how to schedule a response to the request based on these adjusted estimates and scores 422. Although not illustrated in FIG. 4, it is understood that the updated data 402 may further include one or more requests from a user or administrator to manually adjust one or more parameters of the models. For example, a user or administrator may determine that the sentiment detector 416 should pay more attention to a particular element of received requests or pay less attention to one or more user historical trends. In other example embodiments, the amount of available hardware to generate one or more responses to one or more requests may change; therefore, the weights and biases present in the compute estimator 412 and response estimator 414 may change based on these new hardware configurations. It is understood that any similar or suitable changes to each of the models may occur based on any such changes as described herein.

FIG. 5A illustrates a process 510 for scheduling a response to a received query. Each of the actions performed in the process 510 may be executed by a processor, server, or some other suitable computing device. It is understood that each of the actions performed in the process 510 may occur in an order or manner not illustrated in FIG. 5A. Each of the compute estimation model, response time estimation model, and user sentiment model may be integrated into a single computing environment, such as a single server or a collection of processing units. A system may determine 511 via a compute estimation model one or more compute requirements to generate a response to a received query. The system may determine 512 via a response time estimation model the response time for generating the response to the received query. The system may also generate 513 via a user sentiment model a user sentiment score indicating an emotional state associated with the user based on the received query or response. The system may then schedule 514 the response to the received query based at least on the compute requirements, the response time estimate, and the user sentiment score.

FIG. 5B illustrates a process 520 for training at least a compute estimation model, response time model, user sentiment model, and system control model. Each of the actions performed in the process 520 may be executed by a processor, server, or some other suitable computing device. It is understood that each of the actions performed in the process 510 may occur in an order or manner not illustrated in FIG. 5B. A system may include at least a compute response model, a user sentiment model, and a system control model, as discussed with further reference to FIG. 4. A system may determine 522 via a compute estimation model one or more compute requirements to generate a response to a received query. The system may determine 523 via a response time estimation model the response time for generating the response to the received query. The system may also generate 524 via a user sentiment model a user sentiment score indicating an emotional state associated with the user based on the received query or response. The system may then schedule 525 the response to the received query based at least on the compute requirements, the response time estimate, and the user sentiment score. This system may include 526 one or more training steps after scheduling the response, based at least on how each response has been scheduled according to each of the estimates and scores of the models described herein. The iteration step 526 may occur at any or all of the steps described herein in furtherance of the updating and training of each of the models described in action 521.

FIG. 5C illustrates a process 530 for adjusting model parameters according to one or more example embodiments. Each of the actions performed in the process 530 may be executed by a processor, server, or some other suitable computing device. It is understood that each of the actions performed in the process 530 may occur in an order or manner not illustrated in FIG. 5C. The discussion in FIG. 5C may include at least a compute estimation model, response time estimation model, and user sentiment model, all of which are discussed elsewhere herein. A system may receive 531 one or more adjustments to model parameters from a user, administrator, or some other remote computing device. In some example embodiments, a user may adjust one or more model parameters according to one or more changes in external data, such as weather, traffic, or changes in available hardware for computing. In other embodiments, the system may receive one or more adjustments from an administrator who wants to adjust one or more parameters of the models according to one or more outputs of the system control model. Following one or more adjustments, the system may update the one or more model parameters according to the received adjustments. A system may determine 532 via a compute estimation model one or more compute requirements to generate a response to a received query. The system may determine 533 via a response time estimation model the response time for generating the response to the received query. The system may also generate 534 via a user sentiment model a user sentiment score indicating an emotional state associated with the user based on the received query or response. The system may then schedule 535 the response to the received query based at least on the compute requirements, the response time estimate, and the user sentiment score.

As discussed, aspects of various embodiments presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

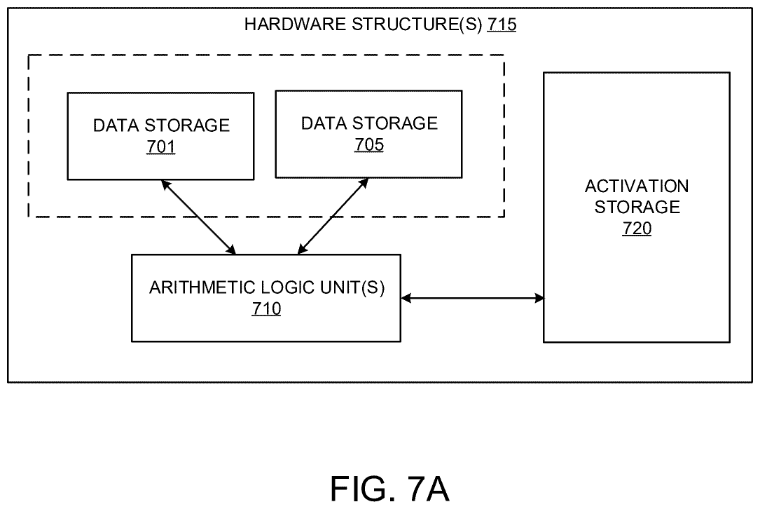

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches-such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

Such components can be used in embodiments described herein.

### Inference and Training Logic

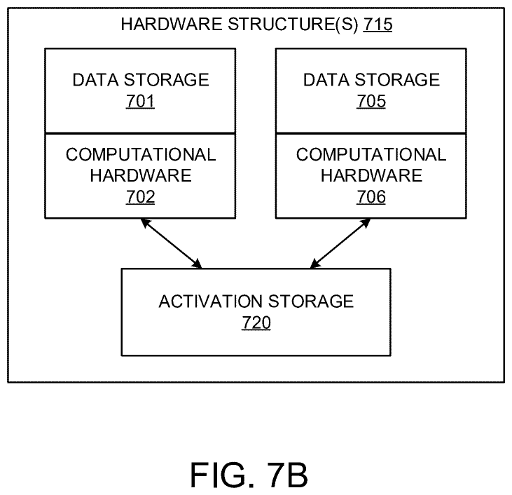

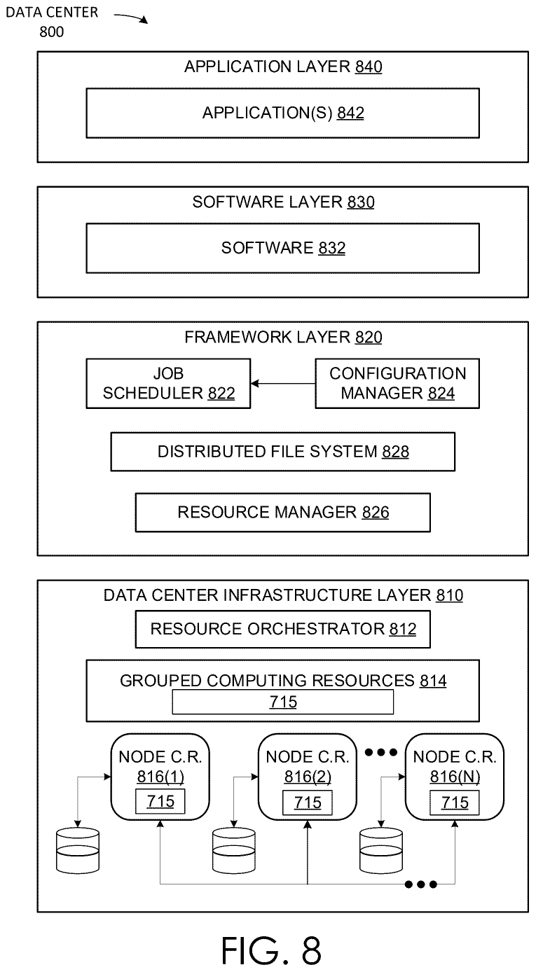

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

Such components can be used in embodiments described herein.

### Data Center

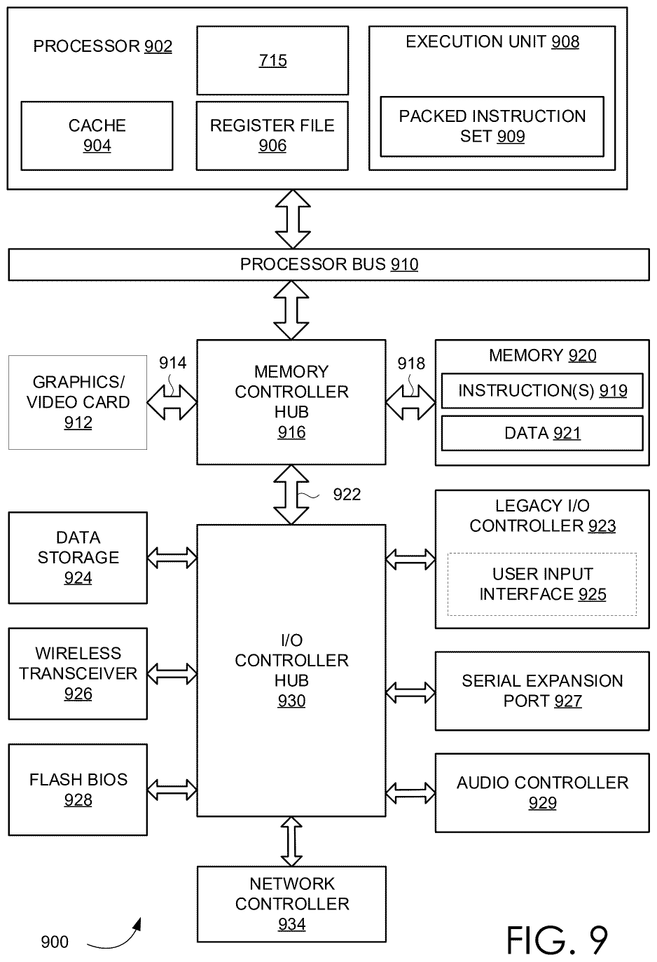

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache SparkTM (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used in embodiments described herein.

### Computer Systems

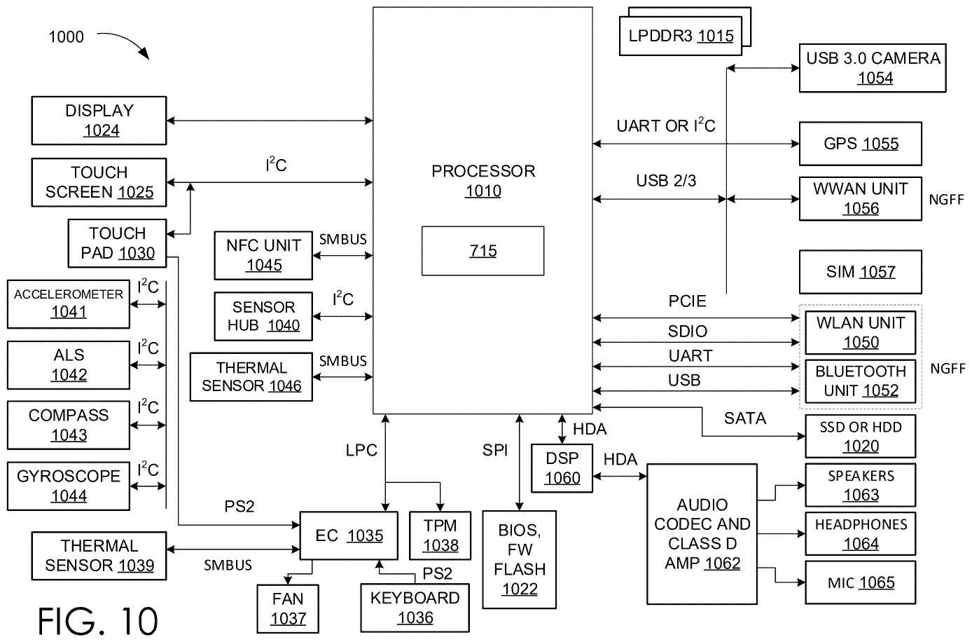

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, XeonTM, Itanium®, XScaleTM and/or StrongARMTM, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used in embodiments described herein.

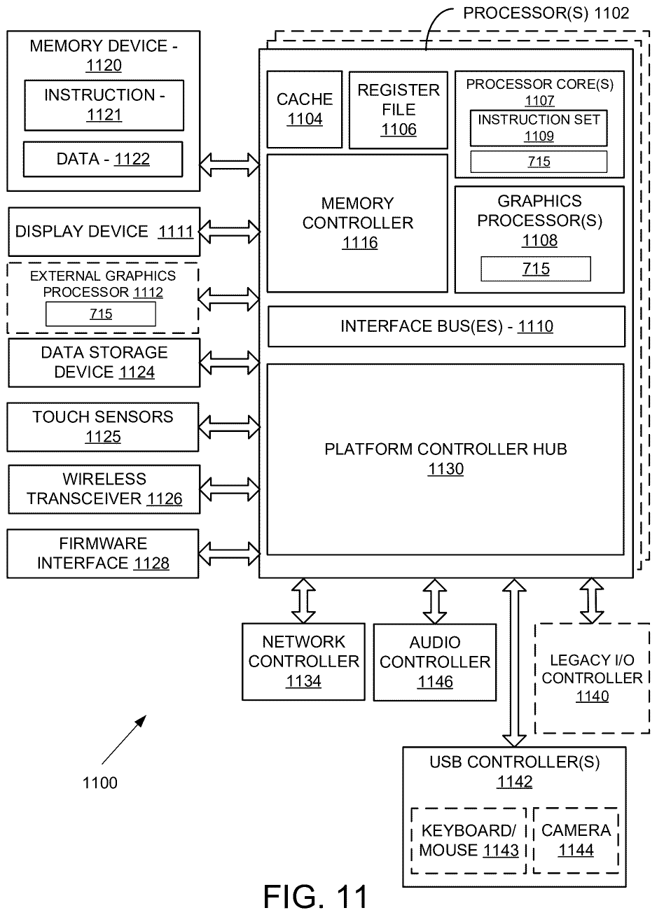

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used in embodiments described herein.

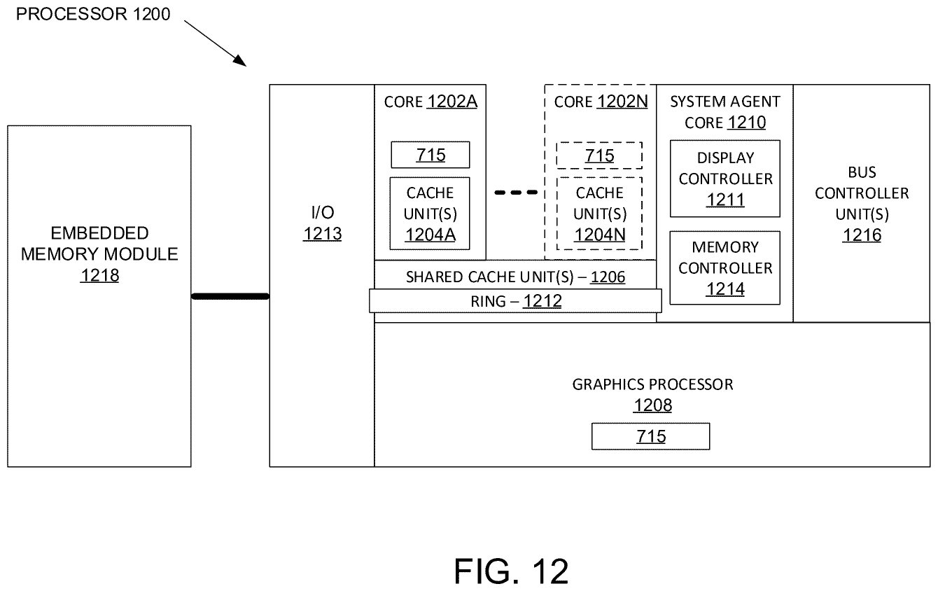

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used in embodiments described herein.

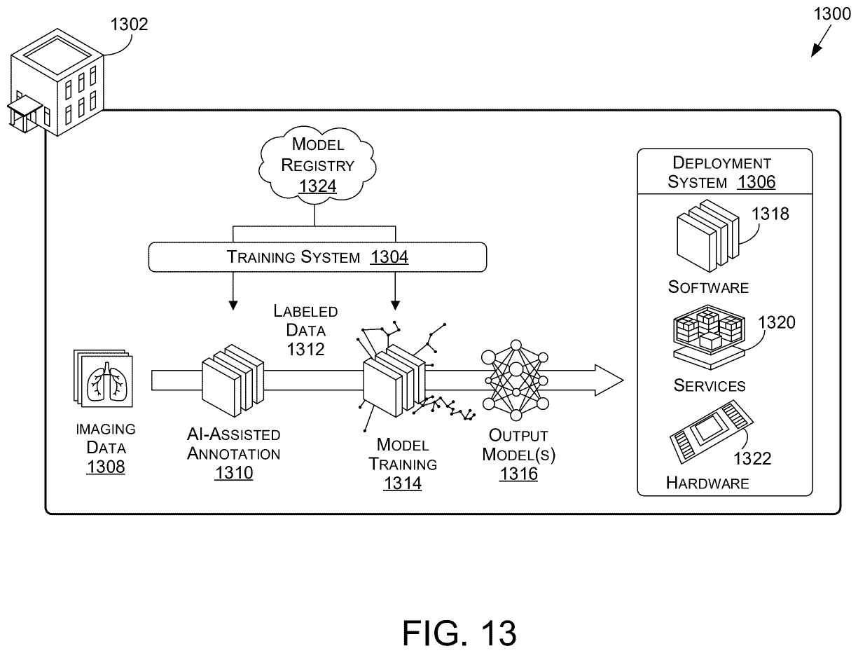

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used in embodiments described herein.

### Virtualized Computing Platform

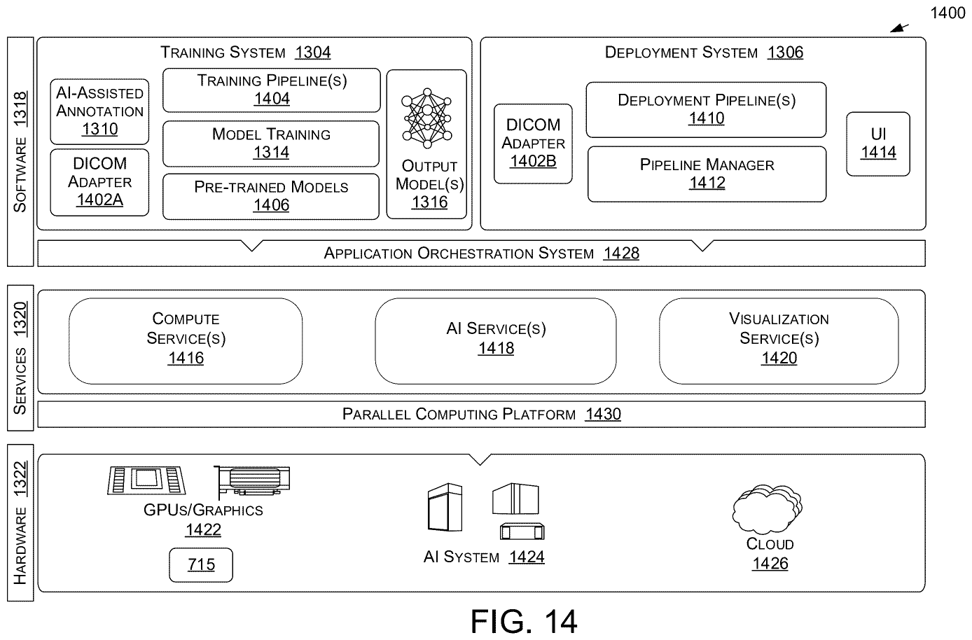

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects - such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

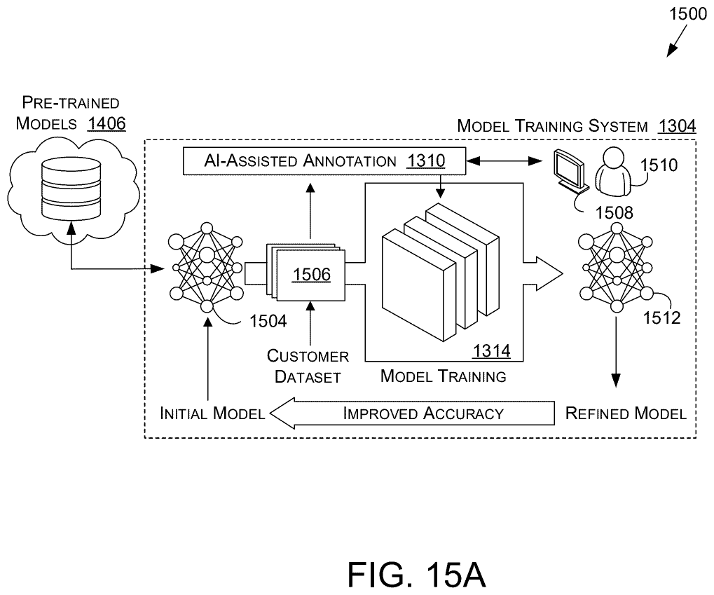

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g., pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as raytracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

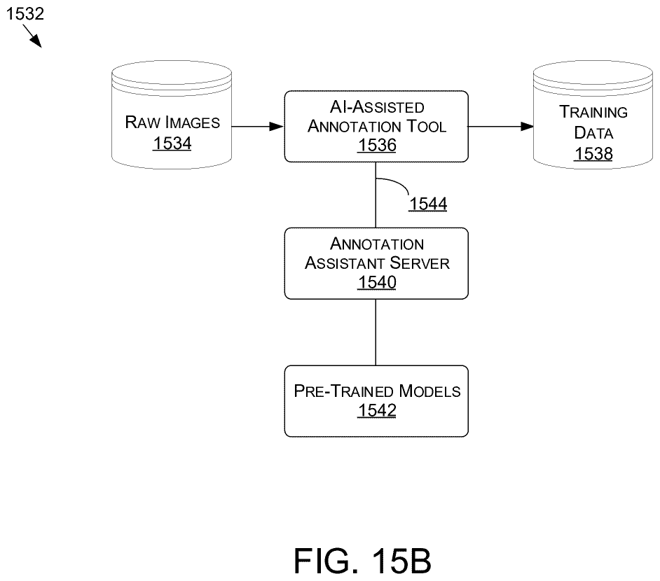

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

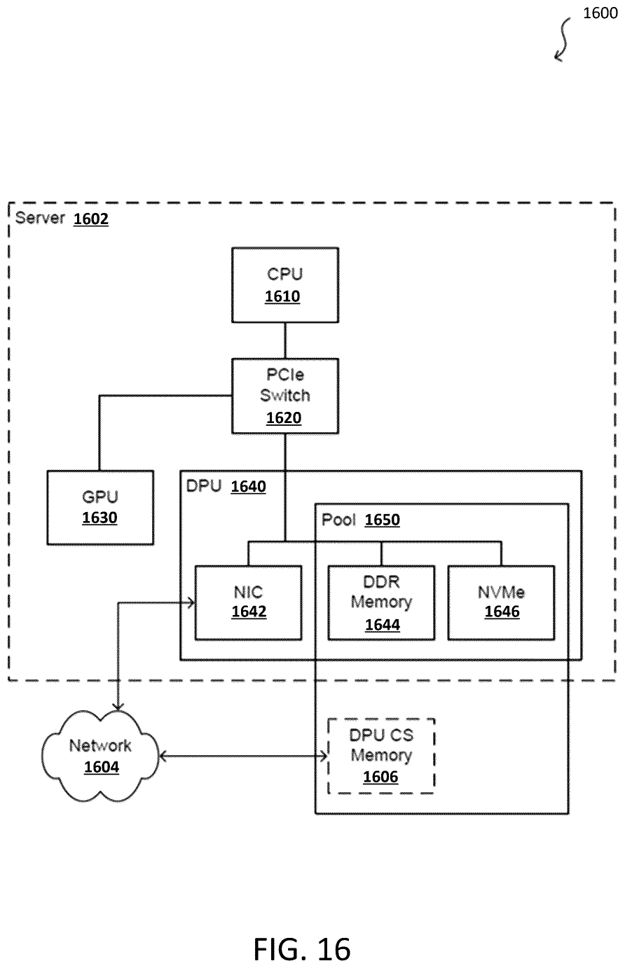

FIG. 16 illustrates an example computing environment 1600 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, example embodiments may be used with a variety of different architectures. The example computing environment 1600 may include a server 1602 which may be used to perform HPC workloads, such as AI training or machine learning model training. In an embodiment, the server 1602 may be an application instance or a compute node. The server 1602 may include a CPU 1610 associated with a switch 1620, such as a peripheral component interconnect express (PCIe) switch, which may control at least some data transmission over communication paths interconnecting various components. In an embodiment, the CPU 110 may include a root complex processor.

The PCIe switch 1620 may also be associated with a GPU 1630 and a DPU 1640, and may transmit data between at least some of the CPU 1610, the GPU 1630, the DPU 1640, and other components. In an embodiment, the PCIe switch 1620 may be associated with more than one GPU or more than one DPU. In another embodiment, the PCIe switch 1620 may be located within the DPU 1640. The PCIe switch 1620 may manage the transfer of at least some data between the CPU 1610, the GPU 1630, and the DPU 1640. In another embodiment, the number of GPUs associated with the PCIe switch 1620 may be equal to the number of DPUs associated with the PCIe switch 1620. In at least one embodiment, the server 1602 may include, without limitation, any number of the CPUs 1610, the PCIe switches 1620, the GPUs 1630, and/or the DPUs 1640, in any combination. For example, in at least one embodiment, server 1602 could include eight, sixteen, thirty-two, and/or more GPUs 1630. In at least one embodiment, communication paths interconnecting various components, including but not limited to the CPU 1610, the PCIe switch 1620, the GPU 1630, and the DPU 1640, in FIG. 16 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 1640 may include a network interface card (NIC) 1642, a DDR memory 1644, and a non-volatile memory express (NVMe) device 1646. The NIC 1642 may be able to interface with a network 1604, which may also interface with additional NVMe devices available to the DPU 1640, such as over fabric. In an embodiment, the DPU 1640 may not include the NVMe device 1646. In another embodiment, the NVMe device 1646 may be located on the server 1602 and not on the DPU 1640. In yet another embodiment, the computing environment 1600 may include more than one of the NVMe device 1646, such as a first NVMe device in the DPU 1640 and a second first NVMe device on the server 1602 an associated directly with the PCIe switch 1620. In an embodiment, the DPU 1640 may not include the DDR memory 1644 and may include a computational storage services (CSS) in place of, or in addition to, the DDR memory 1644. For example, computing environment 1600 may include DPU computational storage (CS) memory 1606 available to the DPU 1640 as part of the CSS. The network 1604 may be able to interface with the DPU CS memory 106 through the NIC 1642, according to any suitable interface protocol, such as remote direct memory access (RDMA) over Ethernet, InfiniBand, Fiber Channel, etc.

The total memory of the computing environment 1600 available for data storage may be expanded through the use of the DPU 1640 on nodes of the system. The DPU 1640 may have access to a pool 1650 of memory already available to the server 1602, such as double data rate (DDR) memory, on-board NVMe devices, NVMe devices over fabric, and CS. The pool 1650 of memory may include at least one of the DDR memory 1644, NVMe 1646, and the DPU CS memory 1606. The DPU 1640 may also be able to access the available memory of other DPUs as part of the pool 1650, and other DPUs may be able to access the available memory of DPU 1640, such as the pool 1650. This available memory can be accessed and utilized for data storage, without the addition of compute resources, such as compute nodes, which would be required using other solutions. The available pool 1650 accessible to the DPU 1640 may be provisioned for the server 1602 to expand the total memory available for data storage, such as to reduce the data storage load on the CPU 1610 or the GPU 1630, which can instead increase the utilization of their memory for processing. For example, during training of an AI, the model states, residual states, activation functions, and checkpoints can be stored, or offloaded, on the pool 1650 accessible to the DPU 1640.

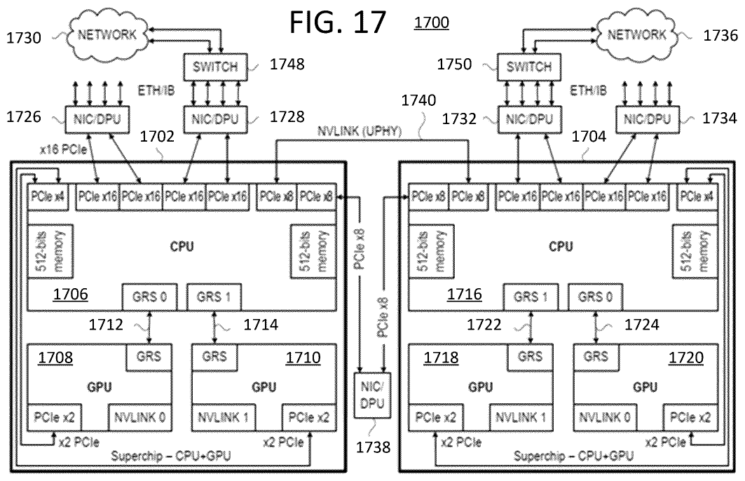

FIG. 17 is a block diagram that schematically illustrates a computing system 1700, e.g., a data center or a High-Performance Computing (HPC) cluster, in accordance with an embodiment that is described herein. System 1700 comprises a plurality of subsystems, e.g., multiple processing devices coupled to each other, multiple network devices, and multiple networks, according to at least one embodiment. Computing system 1700 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1700 and to one or more external networks 1730, 1736. In the present example, system 1700 comprises a packet switch 1748 that connects NIC/DPU 1728 to network 1730, and a packet switch 1750 that connects NIC/DPU 1732 to network 1736.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1700 can include one or more CPUs and one or more GPUs.

FIG. 17 also demonstrates an example architecture of a multi-GPU architecture. As illustrated in the figure, computing system 1700 includes a processing device 1702 with a multi-GPU architecture. In particular, processing device 1702 may be a system-on-chip and includes multiple subsystems such as a CPU 1706, a GPU 1708, and a GPU 1710. CPU 1706 can be coupled to GPU 1708 via a die-to-die (D2D) or chip-to-chip (C2C) interconnect 1712, such as a Ground-Referenced Signaling interconnect (GRS interconnect). CPU 1706 can be coupled to GPU 1710 via a D2D or C2C interconnect 1714. CPU 1706 can also couple to GPU 1708 and GPU 1710 via PCIe interconnects.

CPU 1706 can be coupled to one or more NICs or DPUs, which are coupled to one or more networks. For example, as illustrated in FIG. 17, CPU 1706 is coupled to a first NIC/DPU 1726, which is coupled to a network 1730. CPU 1706 is also coupled to a second NIC/DPU 1728, which is coupled to network 1730 via switch 1748. NIC/DPU 1726 and NIC/DPU 1728 can be coupled to network 1730 over Ethernet (ETH), NVLINK or InfiniBand (IB) connections, for example.

Computing system 1700 also includes a processing device 1704 with a multi-GPU architecture. In particular, processing device 1704 includes multiple subsystems including a CPU 1716, a GPU 1718, and a GPU 1720. CPU 1716 can be coupled to GPU 1718 via an D2D or C2C interconnect 1722. CPU 1716 can be coupled to GPU 1720 via a D2D or C2C interconnect 1724. CPU 1716 can also couple to GPU 1718 and GPU 1720 via PCIe interconnects. CPU 1716 can be coupled to one or more NICs or DPUs, which are coupled to one or more networks. For example, as illustrated in FIG. 17, CPU 1716 is coupled to a first NIC/DPU 1732, which is coupled to a network 1736. CPU 1716 is also coupled to a second NIC/DPU 1734, which is coupled to network 1736 via switch 1750. NIC/DPU 1732 and NIC/DPU 1734 can be coupled to network 1736 over Ethernet (ETH), NVLINK or InfiniBand (IB) connections.

In at least one embodiment, processing device 1702 and processing device 1704 can communication with each other via a NIC/DPU 1738, such as over PCIe interconnects. Processing device 1702 and processing device 1704 can also communicate with each other over a high-bandwidth communication interconnects 1740, such as an NVLink interconnect or other high-speed interconnects. The packet switches in FIG. 17 may comprise, for example, Nvidia Quantum-2 switches. The NICs/DPUs in the figure may comprise, for example, Nvidia Bluefield DPUs.

In various embodiments, any of the network devices of system 1700, e.g., any of NICs/DPUs 1726, 1728, 1732, 1734 and 1738, and/or any of switches 1748 and 1750, may use ILI packets in accordance with the techniques described herein.

In various embodiments, the functions and actions described herein may be performed by a processor (e.g., a central processing unit (CPU) or graphics processing unit (GPU)), data processing units (DPUs), quantum processing units (QPUs), a plurality of parallel processing units (PPUs), and application-specific integrated circuits (ASICs) memory module, or power supply. QPUs configured to perform one or more operations associated with a quantum algorithm. In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with. In at least one embodiment, portions of this functionality can be performed using multiple computing devices, or multiple processors within one or more computing devices, such as may include a combination of CPUs and GPUs (Graphics Processing Unit), (DPUs), (QPUs), a plurality of parallel processing units (PPUs). In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU, DPU, QPU, a plurality of parallel processing units (PPUs). A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

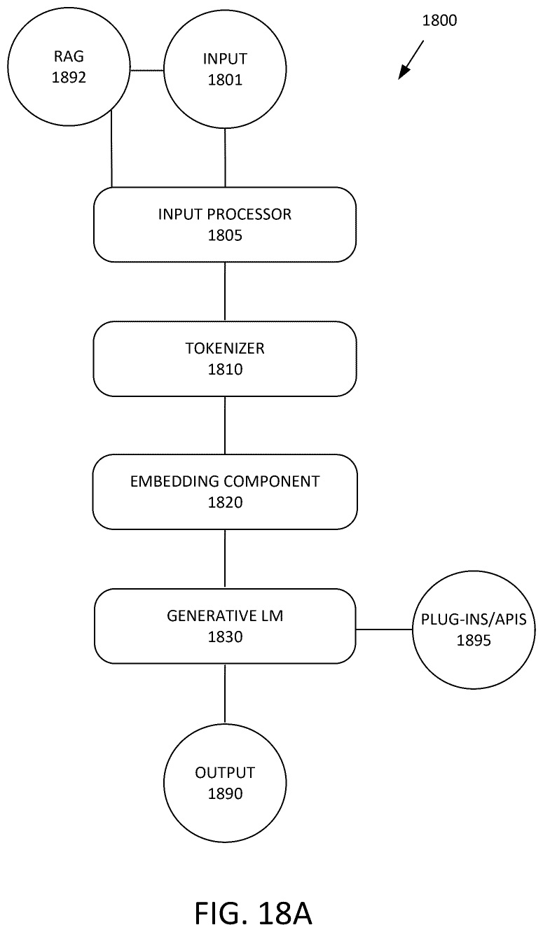

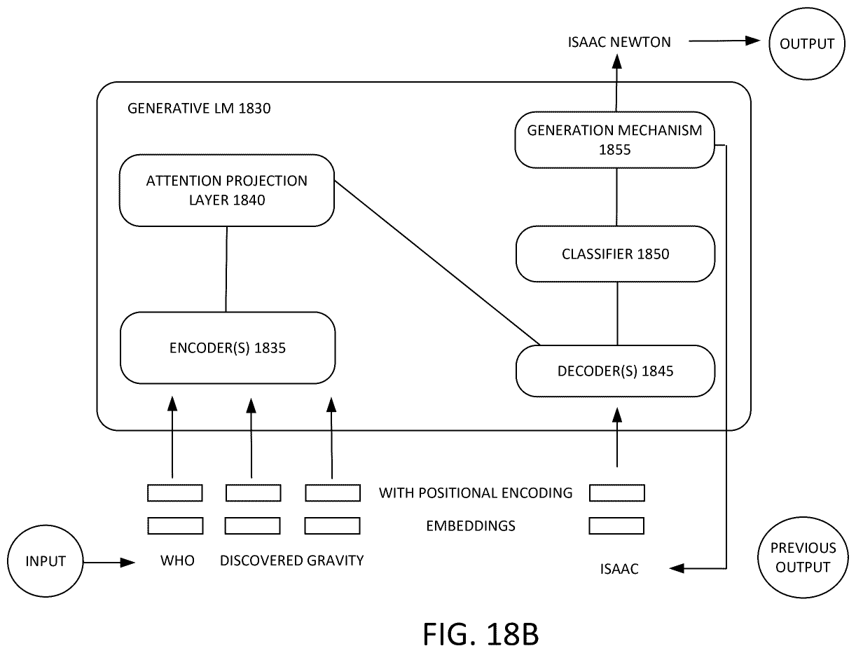

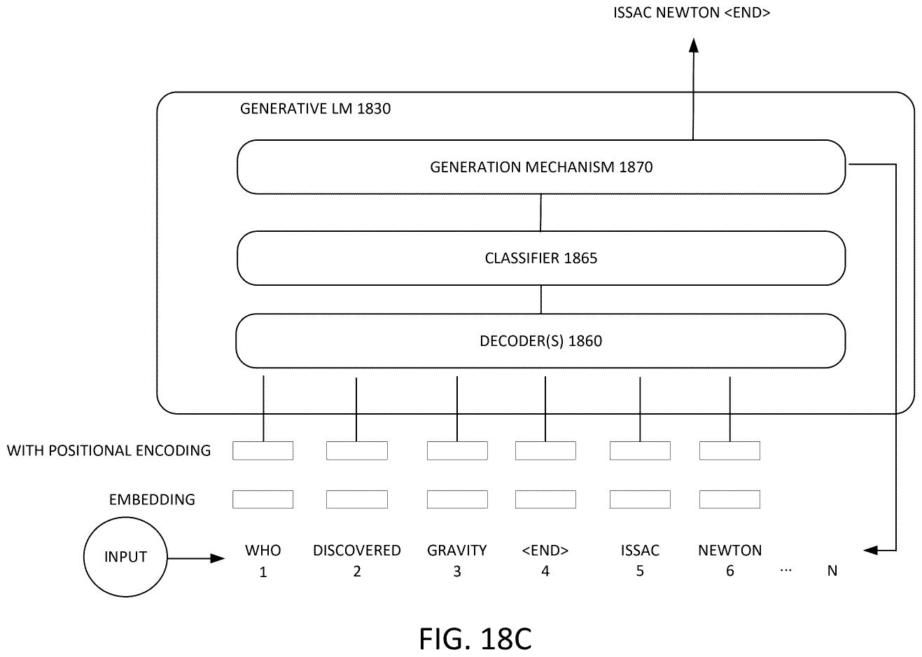

FIG. 18A is a block diagram of an example generative language model system 1800 suitable for use in implementing at least some embodiments of the present disclosure. In the example illustrated in FIG. 18A, the generative language model system 1800 includes a retrieval augmented generation (RAG) component 1892, an input processor 1805, a tokenizer 1810, an embedding component 1820, plug-ins/APIs 1895, and a generative language model (LM) 1830 (which may include an LLM, a VLM, a multi-modal LM, etc.).

At a high level, the input processor 1805 may receive an input 1801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1830 (e.g., LLM/VLM/MMLM/etc.). In some embodiments, the input 1801 includes plain text in the form of one or more sentences, paragraphs, and/or documents. Additionally or alternatively, the input 1801 may include numerical sequences, precomputed embeddings (e.g., word or sentence embeddings), and/or structured data (e.g., in tabular formats, JSON, or XML). In some implementations in which the generative LM 1830 is capable of processing multi-modal inputs, the input 1801 may combine text (or may omit text) with image data, audio data, video data, design data, USD data, and/or other types of input data, such as but not limited to those described herein. Taking raw input text as an example, the input processor 1805 may prepare raw input text in various ways. For example, the input processor 1805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1805 may remove stopwords to reduce noise and focus the generative LM 1830 on more meaningful content. The input processor 1805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1892 (which may include one or more RAG models, and/or may be performed using the generative LM 1830 itself) may be used to retrieve additional information to be used as part of the input 1801 or prompt. RAG may be used to enhance the input to the LLM/VLM/MMLM/etc. with external knowledge, so that answers to specific questions or queries or requests are more relevant—such as in a case where specific knowledge is required. The RAG component 1892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1801 may be generated using the query or input to the model (e.g., a question, a request, etc.) in addition to data retrieved using the RAG component 1892. In some embodiments, the input processor 1805 may analyze the input 1801 and communicate with the RAG component 1892 (or the RAG component 1892 may be part of the input processor 1805, in embodiments) in order to identify relevant text and/or other data to provide to the generative LM 1830 as additional context or sources of information from which to identify the response, answer, or output 1890, generally. For example, where the input indicates that the user is interested in a desired tire pressure for a particular make and model of vehicle, the RAG component 1892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1892 may retrieve a prior stored conversation history—or at least a summary thereof—and include the prior conversation history along with the current ask/request as part of the input 1801 to the generative LM 1830.

The RAG component 1892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1892 and the embeddings of the chunks along with the embeddings of the query may be compared to identify the most similar/related embeddings to the query, which may be supplied to the generative LM 1830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1830 to understand morphological variations and handle out-of-vocabulary words more effectively. Character-based tokenization represents each character as a separate token, enabling the generative LM 1830 to process text at a fine-grained level. The choice of tokenization strategy may depend on factors such as the language being processed, the task at hand, and/or characteristics of the training dataset. As such, the tokenizer 1810 may convert the (e.g., processed) text into a structured format according to tokenization schema being implemented in the particular embodiment.

The embedding component 1820 may use any known embedding technique to transform discrete tokens into (e.g., dense, continuous vector) representations of semantic meaning. For example, the embedding component 1820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1801 includes image data/video data/etc., the input processor 1801 may resize the data to a standard size compatible with format of a corresponding input channel and/or may normalize pixel values to a common range (e.g., 0 to 1) to ensure a consistent representation, and the embedding component 1820 may encode the image data using any known technique (e.g., using one or more convolutional neural networks (CNNs) to extract visual features). In some implementations in which the input 1801 includes audio data, the input processor 1801 may resample an audio file to a consistent sampling rate for uniform processing, and the embedding component 1820 may use any known technique to extract and encode audio features—such as in the form of a spectrogram (e.g., a mel-spectrogram). In some implementations in which the input 1801 includes video data, the input processor 1801 may extract frames or apply resizing to extracted frames, and the embedding component 1820 may extract features such as optical flow embeddings or video embeddings and/or may encode temporal information or sequences of frames. In some implementations in which the input 1801 includes multi-modal data, the embedding component 1820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1830 and/or other components of the generative LM system 1800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1820 may apply an encoded representation of the input 1801 to the generative LM 1830, and the generative LM 1830 may process the encoded representation of the input 1801 to generate an output 1890, which may include responsive text and/or other types of data.

As described herein, in some embodiments, the generative LM 1830 may be configured to access or use—or capable of accessing or using—plug-ins/APIs 1895 (which may include one or more plug-ins, application programming interfaces (APIs), databases, data stores, repositories, etc.). For example, for certain tasks or operations that the generative LM 1830 is not ideally suited for, the model may have instructions (e.g., as a result of training, and/or based on instructions in a given prompt, such as those retrieved using the RAG component 1892) to access one or more plug-ins/APIs 1895 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1895 to the plug-in/API 1895, the plug-in/API 1895 may process the information and return an answer to the generative LM 1830, and the generative LM 1830 may use the response to generate the output 1890. This process may be repeated—e.g., recursively—for any number of iterations and using any number of plug-ins/APIs 1895 until an output 1890 that addresses each ask/question/request/process/operation/etc. from the input 1801 can be generated. As such, the model(s) may not only rely on its own knowledge from training on a large dataset(s) and/or from data retrieved using the RAG component 1892, but also on the expertise or optimized nature of one or more external resources—such as the plug-ins/APIs 1895.

FIG. 18B is a block diagram of an example implementation in which the generative LM 1930 includes a transformer encoder-decoder. For example, assume input text such as “Who discovered gravity” is tokenized (e.g., by the tokenizer 1910 of FIG. 18A) into tokens such as words, and each token is encoded (e.g., by the embedding component 1820 of FIG. 18A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1835 of the generative LM 1930.

In an example implementation, the encoder(s) 1835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1840 may convert the context vector into attention vectors (keys and values) for the decoder(s) 1845.

In an example implementation, the decoder(s) 1845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1835, in an example transformer architecture, each token (e.g., word) flows through a separate path in the decoder(s) 1845. During a first pass, the decoder(s) 1845, a classifier 1850, and a generation mechanism 1855 may generate a first token, and the generation mechanism 1855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1835, except that it creates its queries from the layer below it and takes the keys and values (e.g., matrix) from the output of the encoder(s) 1835.

As such, the decoder(s) 1845 may output some decoded (e.g., vector) representation of the input being applied during a particular pass. The classifier 1850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1855 may select or sample a word or token based on a corresponding predicted probability (e.g., select the word with the highest predicted probability) and append it to the output from a previous pass, generating each word or token sequentially. The generation mechanism 1855 may repeat the process, triggering successive decoder inputs and corresponding predictions until selecting or sampling a symbol or token that represents the end of the response, at which point, the generation mechanism 1855 may output the generated response.

FIG. 18C is a block diagram of an example implementation in which the generative LM 1830 includes a decoder-only transformer architecture. For example, the decoder(s) 1860 of FIG. 18C may operate similarly as the decoder(s) 1845 of FIG. 18B except each of the decoder(s) 1860 of FIG. 18C omits the encoder-decoder self-attention layer (since there is no encoder in this implementation). As such, the decoder(s) 1860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1860. As with the decoder(s) 1845 of FIG. 18B, each token (e.g., word) may flow through a separate path in the decoder(s) 1860, and the decoder(s) 1860, a classifier 1865, and a generation mechanism 1870 may use auto-regression to sequentially generate one token at a time until predicting a symbol or token that represents the end of the response. The classifier 1865 and the generation mechanism 1870 may operate similarly as the classifier 1850 and the generation mechanism 1855 of FIG. 18B, with the generation mechanism 1870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

Various embodiments can be described by the following clauses:
1. A system comprising:
at least one scheduler processor configured to:
determine, via a compute estimation model and based at least on a received query including one or more tokens, one or more compute requirements to generate a response to the received query;
determine, via a response time estimation model and based at least on the received query, a response time for generating a response to the received query;
generate, via a user sentiment model and based at least on the received query, a user sentiment score indicating, at least, an emotional state associated with the user; and
schedule the response to the received query based at least on the compute requirements, the response time, and the user sentiment score.
2. The system of clause 1, wherein scheduling the response further comprises scheduling a response to the received query ahead of one or more responses to earlier queries based at least on the compute requirements, the response time, and the user sentiment score.
3. The system of clause 1, wherein the scheduler processor is further configured to infer, based at least on the user sentiment score, that the response to the received query is time-sensitive.
4. The system of clause 1, wherein the user sentiment score is based at least on query length, frequency of repeated queries, one or more historical user sentiment scores, or historical sentiment trends associated with one or more historical queries of the user.
5. The system of clause 1, wherein the response time is determined further based at least on hardware allocation or historical response times.
6. The system of clause 1, wherein the compute estimation is determined further based at least on historical compute requirements of historical queries.
7. The system of clause 1, wherein the at least one scheduler processor is further configured to allow a user to adjust one or more weights assigned with the compute estimation model, the response time estimation model, or the user sentiment model.
8. The system of clause 7, wherein the at least one scheduler processor allows the user to adjust the weights based on one or more outputs of a system control model configured to generate recommendations regarding the weights of the model.
9. a method, comprising:
determining, via a compute estimation model and based at least on a query, one or more compute requirements for processing the query;
determining, via a response time estimation model and based at least on the query, a response time for processing the query;
generating, via a user sentiment model and based at least on the query, a user sentiment score; and
scheduling a response to the query based on at least one of the compute requirements, the response time, or the user sentiment score.
10. The method of clause 9, wherein the compute estimation model is trained based at least on actual compute requirements.
11. The method of clause 9, wherein the response time model is trained based at least on actual response times corresponding to allocated hardware.
12. The method of clause 9, wherein the scheduling the response further comprises scheduling the response to the query ahead of one or more responses to earlier queries based on at least one of the compute requirements, the response time, or the user sentiment score.
13. The method of clause 9, wherein the user sentiment score is based at least on a length of the query or one or more previous queries submitted by the user within a predetermined time period.
14. The method of clause 9, further comprising adjusting one or more weights of the compute estimation model, the response time estimation model, or the user sentiment model.
15. At least one processor comprising one or more logical units to schedule a response to a query based at least on compute requirements for processing the query determined using a first model, response time for processing the query determined using a second model, and a user sentiment score based on the query determined using a third model.
16. The at least one processor of clause 15, wherein the user sentiment score is based at least on one or more emotional scores indicating one or more emotional states associated with the user based at least on the query.
17. The at least one processor of clause 15, wherein the user sentiment score is based at least on an urgency detected in the query.
18. The at least one processor of clause 15, wherein at least one of the first model, the second model, or the third model is updated in response to the query or the scheduled response.
19. The at least one processor of clause 15, wherein the one or more logical units are further configured to receive, from an administrator, an adjustment request to adjust one or more weights assigned to one or more outputs of each of the first model, the second model, and the third model.
20. The at least one processor of clause 15, wherein the at least one processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
at least one scheduler processor configured to:
determine, via a compute estimation model and based at least on a received query including one or more tokens, one or more compute requirements to generate a response to the received query;
determine, via a response time estimation model and based at least on the received query, a response time for generating a response to the received query;
generate, via a user sentiment model and based at least on the received query, a user sentiment score indicating, at least, an emotional state associated with the user; and
schedule the response to the received query based at least on the compute requirements, the response time, and the user sentiment score.

2. The system of claim 1, wherein scheduling the response further comprises scheduling a response to the received query ahead of one or more responses to earlier queries based at least on the compute requirements, the response time, and the user sentiment score.

3. The system of claim 1, wherein the scheduler processor is further configured to infer, based at least on the user sentiment score, that the response to the received query is time-sensitive.

4. The system of claim 1, wherein the user sentiment score is based at least on query length, frequency of repeated queries, one or more historical user sentiment scores, or historical sentiment trends associated with one or more historical queries of the user.

5. The system of claim 1, wherein the response time is determined further based at least on hardware allocation or historical response times.

6. The system of claim 1, wherein the compute estimation is determined further based at least on historical compute requirements of historical queries.

7. The system of claim 1, wherein the at least one scheduler processor is further configured to allow a user to adjust one or more weights assigned with the compute estimation model, the response time estimation model, or the user sentiment model.

8. The system of claim 7, wherein the at least one scheduler processor allows the user to adjust the weights based on one or more outputs of a system control model configured to generate recommendations regarding the weights of the model.

9. A method, comprising:
determining, via a compute estimation model and based at least on a query, one or more compute requirements for processing the query;
determining, via a response time estimation model and based at least on the query, a response time for processing the query;
generating, via a user sentiment model and based at least on the query, a user sentiment score; and
scheduling a response to the query based on at least one of the compute requirements, the response time, or the user sentiment score.

10. The method of claim 9, wherein the compute estimation model is trained based at least on actual compute requirements.

11. The method of claim 9, wherein the response time model is trained based at least on actual response times corresponding to allocated hardware.

12. The method of claim 9, wherein the scheduling the response further comprises scheduling the response to the query ahead of one or more responses to earlier queries based on at least one of the compute requirements, the response time, or the user sentiment score.

13. The method of claim 9, wherein the user sentiment score is based at least on a length of the query or one or more previous queries submitted by the user within a predetermined time period.

14. The method of claim 9, further comprising adjusting one or more weights of the compute estimation model, the response time estimation model, or the user sentiment model.

15. At least one processor comprising one or more logical units to schedule a response to a query based at least on compute requirements for processing the query determined using a first model, response time for processing the query determined using a second model, and a user sentiment score based on the query determined using a third model.

16. The at least one processor of claim 15, wherein the user sentiment score is based at least on one or more emotional scores indicating one or more emotional states associated with the user based at least on the query.

17. The at least one processor of claim 15, wherein the user sentiment score is based at least on an urgency detected in the query.

18. The at least one processor of claim 15, wherein at least one of the first model, the second model, or the third model is updated in response to the query or the scheduled response.

19. The at least one processor of claim 15, wherein the one or more logical units are further configured to receive, from an administrator, an adjustment request to adjust one or more weights assigned to one or more outputs of each of the first model, the second model, and the third model.

20. The at least one processor of claim 15, wherein the at least one processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
